(19) United States
(12) Patent Application Publication
(10) Pub. No.: US 2013/0336218 A1
(43) Pub. Date: Dec. 19, 2013

(54) HANDLING DUAL PRIORITY CONFIGURATIONS IN A WIRELESS COMMUNICATION NETWORK

(71) Applicant: Vivek Gupta, San Jose, CA (US)

(72) Inventor: Vivek Gupta, San Jose, CA (US)

(21) Appl. No.: 13/971,795

(22) Filed: Aug. 20, 2013

Related U.S. Application Data
(63) Continuation of application No. 13/623,779, filed on Sep. 20, 2012.
Application No. 13/623,779 is a continuation-in-part of application No. 13/526,307, filed on Jun. 18, 2012.
Application No. 13/623,779 is a continuation-in-part of application No. 13/526,307, filed on Jun. 18, 2012.
(60) Provisional application No. 61/595,576, filed on Feb. 6, 2012.
(60) Provisional application No. 61/595,576, filed on Feb. 6, 2012.

(51) Int. Cl. H04W 76/02

(52) U.S. Cl. CPC H04W 76/021
USPC 370/328

(57) ABSTRACT

Embodiments of the present disclosure describe techniques in which a device may transmit, to a network controller of an evolved packet system (EPS), a first non-access stratum (NAS) message including a device properties information element (IE) with a low-priority indicator set to indicate a mobile station (MS) is configured for NAS signaling low priority; transmit a second NAS message to establish a packet data network (PDN) connection, the second NAS message including a low-priority indicator set to indicate the MS is not configured for NAS signaling low priority; and perform an EPS session management (ESM) procedure related to the PDN connection or an EPS mobility management procedure related to the PDN. Other embodiments may be described and claimed.

### CROSS REFERENCE TO RELATED APPLICATIONS

The present application is a continuation of U.S. application Ser. No. 13/623,779, filed Sep. 28, 2012, entitled “Handling Dual Priority Configurations In A Wireless Communication Network,” and a continuation-in-part of U.S. application Ser. No. 13/526,307, filed Jun. 18, 2012, entitled “Handling Dual Priority Applications In A Wireless Communication Network.” U.S. application Ser. No. 13/623,779 is a continuation-in-part of U.S. application Ser. No. 13/526,307. U.S. application Ser. Nos. 13/623,779 and 13/526,307 claim priority to U.S. Provisional Patent Application No. 61/595,576, filed Feb. 6, 2012, entitled “Advanced Wireless Communication Systems and Techniques.” The specifications of these applications are hereby incorporated by reference in their entireties for all purposes.

### FIELD

Embodiments of the present disclosure generally relate to the field of wireless communication systems, and more particularly, to machine-to-machine communications in wireless communication networks.

### BACKGROUND

Machine-to-machine (“M2M”) wireless machines or devices (hereafter referred to as “M2M devices”) may communicate primarily or exclusively with other M2M devices, with little or no human intervention. Examples of M2M devices may include wireless weather sensors, assembly line sensors, meters to track vehicles of a fleet, and so forth. In many cases these M2M devices may connect to a wireless network and communicate, e.g., over a wide area network such as the Internet, with a network server. M2M devices may be used with the IEEE 802.16 standard, IEEE Std. 802.16-2009, published May 29, 2009 (“WiMAX”), as well as in Third Generation Partnership Project (“3GPP”) networks. In parlance of the 3GPP Long Term Evolution (“LTE”) Release 10 (March 2011) (the “LTE Standard”), M2M communications may alternatively be referred to as “machine-type communications” (“MTC”). From a network perspective, M2M communications may be considered to be relatively low-priority communications due to their relatively high latency tolerances and infrequent data transfers. However, most M2M devices that normally communicate on a low priority level may have rare occasions when they need to communicate on a priority level that is higher than a low priority.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example wireless communication network in accordance with some embodiments.

FIGS. 2 and 3 are block diagrams illustrating example communications between user equipment (mobile device) and a wireless communication network in accordance with some embodiments.

FIG. 4 is a process flow diagram for communications between a network controller and user equipment in a wireless communication network in accordance with some embodiments.

FIG. 5 is a process flow diagram for handling a dual priority by user equipment in a wireless network environment in accordance with some embodiments.

FIG. 6 is a process flow diagram for handling a dual priority by user equipment in a congested wireless network environment in accordance with some embodiments.

FIG. 7 illustrates an example system that may be used to practice various embodiments described herein.

### DETAILED DESCRIPTION

Embodiments of the present disclosure provide data techniques and configurations for handling dual-priority devices in a wireless communication network. In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations are described as multiple discrete operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application-Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Example embodiments may be described herein in relation to wireless communication networks including networks such as 3^{rd} Generation Partnership Project (3GPP) Long Term Evolution (LTE) networks including any amendments, updates, and/or revisions (e.g., LTE Release 10 (also referred to as LTE-Advanced (LTE-A), LTE Release 11, etc.), Worldwide Interoperability for Microwave Access (WiMAX) networks, and the like. The embodiments described herein may operate in relation to a radio access network, e.g., an evolved Universal Terrestrial Radio Access Network (E-UTRAN) having evolved node base stations (eNBs), and a core network, e.g., an evolved packet core having gateways, management entities, etc.

In other embodiments, communication schemes described herein may be compatible with additional/alternative communication standards, specifications, and/or protocols. For example, embodiments of the present disclosure may be applied to other types of wireless networks where similar advantages may be obtained. Such networks may include, but are not limited to, wireless local area networks (WLANs), wireless personal area networks (WPANs) and/or wireless wide area networks (WWANs) such as cellular networks and the like.

The following embodiments may be used in a variety of applications including transmitters and receivers of a mobile wireless radio system. Radio systems specifically included within the scope of the embodiments include, but are not limited to, network interface cards (NICs), network adaptors, base stations, access points (APs), relay nodes, eNBs, gateways, bridges, hubs and satellite radiotelephones. Further, the radio systems within the scope of embodiments may include satellite systems, personal communication systems (PCS), two-way radio systems, global positioning systems (GPS), two-way pagers, personal computers (PCs) and related peripherals, personal digital assistants (PDAs), personal computing accessories and all existing and future arising systems which may be related in nature and to which the principles of the embodiments could be suitably applied.

Techniques described herein provide for enabling user equipment (UE) such as an M2M device to provide at least two priority levels (e.g., dual priority) for communications initiated by the UE in a wireless network environment. In some wireless communication environments, the M2M network overload control work may be simplified by restricting M2M devices to a single priority level for all applications executing on the M2M device. The device may be assigned a priority level of either “low priority” or “normal priority.” In practice, significant number of machine type communications may be categorized as “low priority” and hence the M2M devices may be assigned that setting.

However, most M2M devices that normally use “low priority” may also have infrequent, rare occasions when they need to use the “normal” priority setting. For example, electricity meters sending a daily report (e.g., of the per hour usage) may send the report as “low priority.” However, there may be instances in which the electricity meter may want to send an alarm with “normal priority,” for example, if the meter is being tampered with or is being vandalized.

In another example, a road temperature sensor may send daily “I′m still working” communications with “low priority” but, if the road temperature falls to sub-zero, may need to immediately send a warning to the control center with “normal priority.”

In yet another example, an M2M device may host multiple applications. For example, a room temperature application residing on an M2M device may require data transmission using “low priority,” while a video-streaming application residing on the same device may require data transmission using “normal priority.” The embodiments described herein are not limited to the above examples; the above examples are included for illustration of the techniques described in the present disclosure.

If the device may only use either “low priority” or “normal priority” levels for communications, the need for a truly “low priority” device to support rare “normal priority” events may dissuade MTC customers from using the “low priority” setting for their M2M devices. Instead, the MTC customers may be encouraged to configure their devices for “normal priority” level of communications at all times. This may have undesirable consequences with respect to additional network overload.

Embodiments of the present invention provide applications that may reside on an M2M device with the ability to override the device's default “low priority” setting in cases when the applications may need to transmit a “normal priority” communication.

In one embodiment, the UE and/or communications initiated by the UE (e.g., requests initiated by the applications hosted by the UE) may be assigned a default (e.g., low) priority level. In some cases, for example, in emergency and other situations described below in greater detail, the UE may be configured to override the default priority associated with the initiated request and assign a higher (e.g., “normal”) priority level to the initiated request that may be treated by the network according to the assigned priority level. For example, the network may be congested and may not immediately accept a request or other communication from the UE that is associated with a default priority (or lower level of priority), but may accept and process a request or other communications from the UE that is associated with a higher (normal) level that may be assigned to the communication by the UE. More specifically, if the network is determined to be congested and therefore unable to process a request with a default (low) priority from the UE, the network may provide to the UE a wait time value, during which the UE may refrain from attempting to contact the network with communications with low priority. However, if the UE initiates requests with a higher (normal) priority level, these requests may be allowed to be accepted by the network.

In another embodiment, it may be desired for the UE to have a capability to override access control configurations associated with the UE, such as Extended Access Barring configuration. Extended Access Barring (EAB) is a mechanism for the operator(s) to control mobile originating access attempts from UEs that are configured for EAB in order to prevent overload of the access network and/or the core network. In congestion or overload situations, the operator may restrict access from UEs configured for EAB while permitting access from other UEs. UEs configured for EAB are considered more tolerant to access restrictions than other UEs. When an operator determines that it is appropriate to apply EAB, the network broadcasts necessary information to provide EAB control for UEs in a specific area.

However, in some instances, the Extended Access Barring configuration may need to be overridden, typically in conjunction with low priority override capability as described above. This may relate to the fact that typically UEs configured for low access priority are also configured for EAB. Accordingly, when it is necessary to override low priority for a communication initiated by a UE, it may also be necessary to override an EAB setting in order to allow the communication to proceed. Operations of UEs configured to provide dual priority for communications initiated by the UEs in different situations are described below in greater detail.

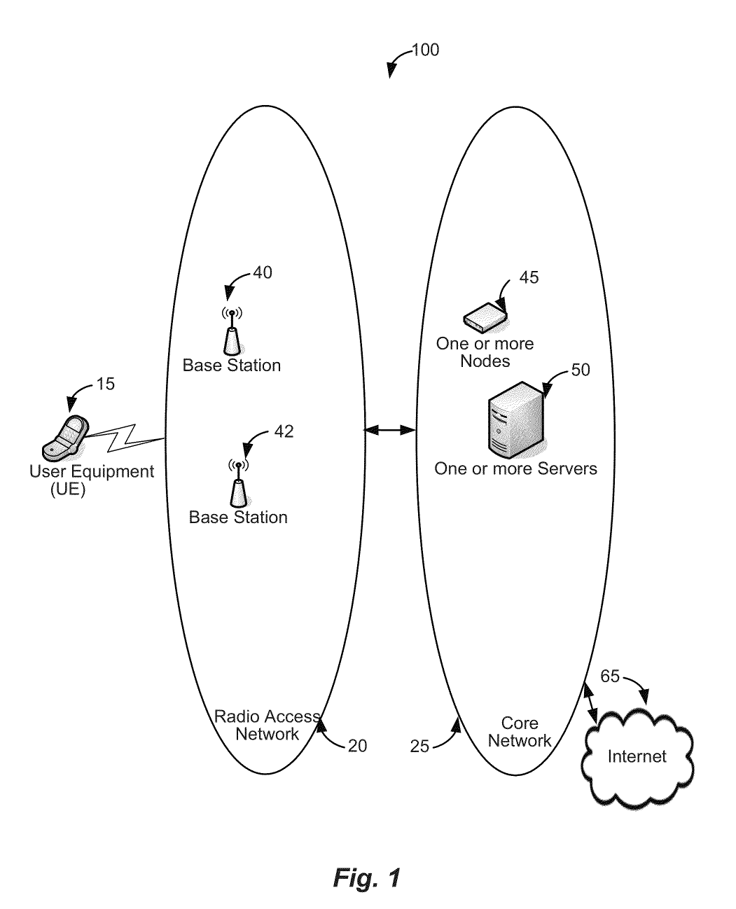

FIG. 1 schematically illustrates an example wireless network 100 in accordance with some embodiments. The network 100 may include a RAN 20 and a core network 25. In some embodiments, the network 100 may be an LTE network, the RAN 20 may be a E-UTRAN, and the core network 25 may be an Evolved Packet System (EPS) type core network. A UE 15 may access the core network 25 via a radio link (“link”) with an eNB such as, for example, one of eNBs 40, 42, etc., in the RAN 20. The UE 15 may be, for example, a subscriber station (e.g., an M2M device) that is configured to communicate with the eNBs 40, 42 in conformance with one or more protocols. The following description is provided for an example network 100 that conforms with 3GPP for ease of discussion; however, subject matter of the present disclosure is not limited in this regard and the described embodiments may apply to other networks that benefit from the principles described herein. In some embodiments, the UE 15 may be configured to communicate using a multiple-input and multiple-output (MIMO) communication scheme. One or more antennas of the UE 15 may be used to concurrently utilize radio resources of multiple respective component carriers (e.g., which may correspond with antennas of eNBs 40, 42) of RAN 20. The UE 15 may be configured to communicate using Orthogonal Frequency Division Multiple Access (OFDMA) in, e.g., downlink communications, and/or Single-Carrier Frequency Division Multiple Access (SC-FDMA) in, e.g., uplink communications in some embodiments.

While FIG. 1 generally depicts the UE 15 as a mobile device (e.g., a cellular phone), in various embodiments the UE 15 may be a personal computer (PC), a notebook, ultrabook, netbook, smartphone, an ultra mobile PC (UMPC), a handheld mobile device, an universal integrated circuit card (UICC), a personal digital assistant (PDA), a Customer Premise Equipment (CPE), a tablet, or other consumer electronics such as MP3 players, digital cameras, and the like. As discussed above, the UE 15 may be a Machine-Type Communication (MTC) device, also known as M2M device. In the present disclosure, the terms “UE” and “device” will be used interchangeably for simplicity purposes. The eNBs 40, 42 may include one or more antennas, one or more radio modules to modulate and/or demodulate signals transmitted or received on an air interface, and one or more digital modules to process signals transmitted and received on the air interface.

In some embodiments, communication with the UE 15 via RAN 20 may be facilitated via one or more nodes 45 (e.g., Radio Network Controllers). The one or more nodes 45 may act as an interface between the core network 25 and the RAN 20. According to various embodiments, the one or more nodes 45 may include a Mobile Management Entity (MME) that is configured to manage signaling exchanges (e.g., authentication of the UE 15) between the base stations 40, 42 and the core network 25 (e.g., one or more servers 50), a Packet Data Network Gateway (PGW) to provide a gateway router to the Internet 65, and/or a Serving Gateway (SGW) to manage user data tunnels or paths between the eNBs 40, 42 of the RAN 20 and the PGW. Other types of nodes may be used in other embodiments.

The core network 25 may include logic (e.g., a module) to provide authentication of the UE 15 or other actions associated with establishment of a communication link to provide a connected state of the UE 15 with the network 100. For example, the core network 25 may include one or more servers 50 that may be communicatively coupled to the base stations 40, 42. In an embodiment, the one or more servers 50 may include a Home Subscriber Server (HSS), which may be used to manage user parameters such as a user's International Mobile Subscriber Identity (IMSI), authentication information, and the like. The core network 25 may include other servers, interfaces, and modules. In some embodiments, logic associated with different functionalities of the one or more servers 50 may be combined to reduce a number of servers, including, for example, being combined in a single machine or module.

According to various embodiments, the network 100 may be an Internet Protocol (IP) based network. For example, the core network 25 may be, at least in part, an IP based network, such as a packet switched (PS) network. Interfaces between network nodes (e.g., the one or more nodes 45) may be based on IP, including a backhaul connection to the base stations 40, 42. In some embodiments, the network 100 may be enabled to provide connection with a circuit switched (CS) network (e.g., CS domain). In an embodiment, a UE 15 may communicate with the network 100 according to one or more communication protocols, such as, for example, Radio Resource Control (RRC) protocol adapted for LTE communication environment.

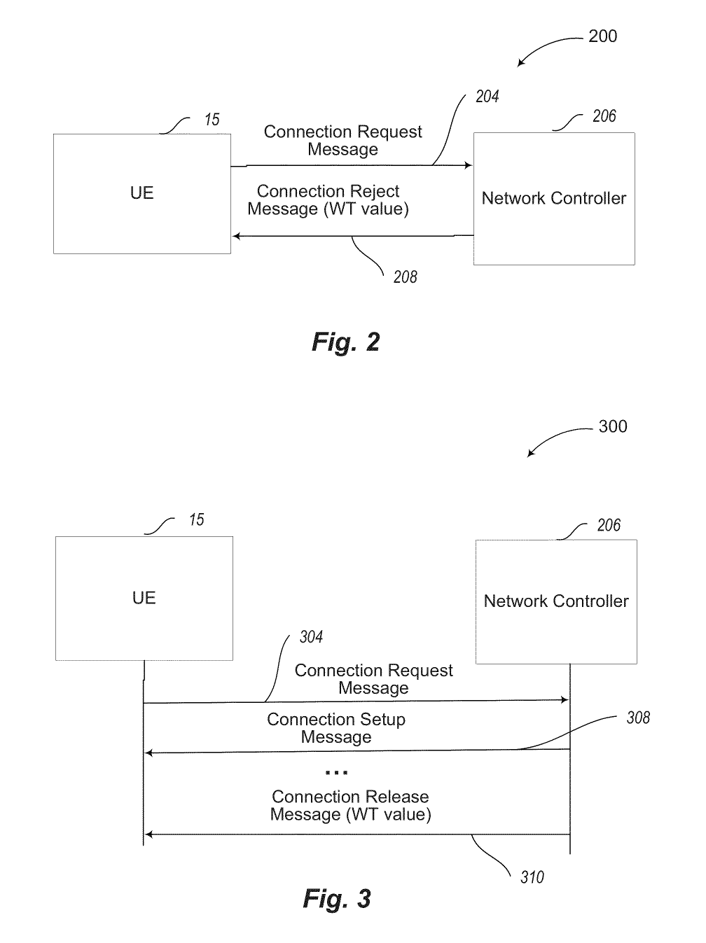

An example connection diagram between the UE 15 and the network 100 is illustrated in FIG. 2. As the diagram 200 illustrates, the UE 15 may send an RRC connection request message 204 to a network controller 206. The RRC connection request message 204 may be a request by the UE 15 for allocation of radio resources so that the UE 15 may exchange data with the RAN 20. The network controller 206 may control establishment and/or maintenance of RRC connections between the UE 15 and the RAN 20. The network controller 206 may be disposed in an eNB 40 or 42 with which the UE 15 attempts to establish an RRC connection. In other embodiments, the network controller 206, or components thereof, may be disposed in additional/alternative network entities, e.g., within a node of the one or more nodes 45, a server of the one or more servers 50, etc.

If the RAN 20 is congested and is not be able to support an RRC connection associated with the RRC connection request message 204, the network controller 206 may respond with an RRC connection reject message 208 to reject the RRC connection request message 204. In this case an RRC connection between the UE 15 and the RAN 20 may not be established. In one example, an RRC connection request message may relate to a NAS request message, such as attach request, tracking area update request, or extended service request.

In some instances, for particular types of devices, such as MTC devices, the network controller 206 may provide, in the connection reject message 208, a wait time (WT) value also known as extended wait time or EWTA timer associated with the device (known as a “backoff timer”) may start running for the duration of the wait time and may keep the device “on hold,” e.g., refraining from sending communications to the network, until the wait time expires and the device may be allowed to resend the request to the network.

A wait time value may be provided to the device (UE) in other instances. FIG. 3 is a block diagram 300 illustrating an instance where the UE 15 may initiate a connection request by sending an RRC connection request message 304 to the network controller 206. The network controller 206 in this instance may determine that the RAN 20 may be able to support an RRC connection associated with the RRC connection request message 304. Accordingly, the network controller 206 may respond with a connection setup message 308. A number of other handshake messages (not shown) may be transmitted between the UE 15 and the network controller 206 in accordance with an adapted communication protocol. For example, the UE 15 may respond to the connection setup message 308 with a notification that a connection setup is complete; the network controller 206 may issue a security mode establishment command; the UE 15 may notify the network controller 206 that the security mode has been established. In one embodiment, the network controller 206 may provide an RRC connection release message 310 that may include a wait time value. In summary, when the network is congested or overloaded, the network controller 206 may specify an extended wait time and ask the UE 15 to “back off' for the duration of the wait time. The foregoing describes how a UE 15 configured for dual priority may handle the situations when the network is congested and the UE 15 receives the wait time value from the network in response to a request (e.g., a connection request).

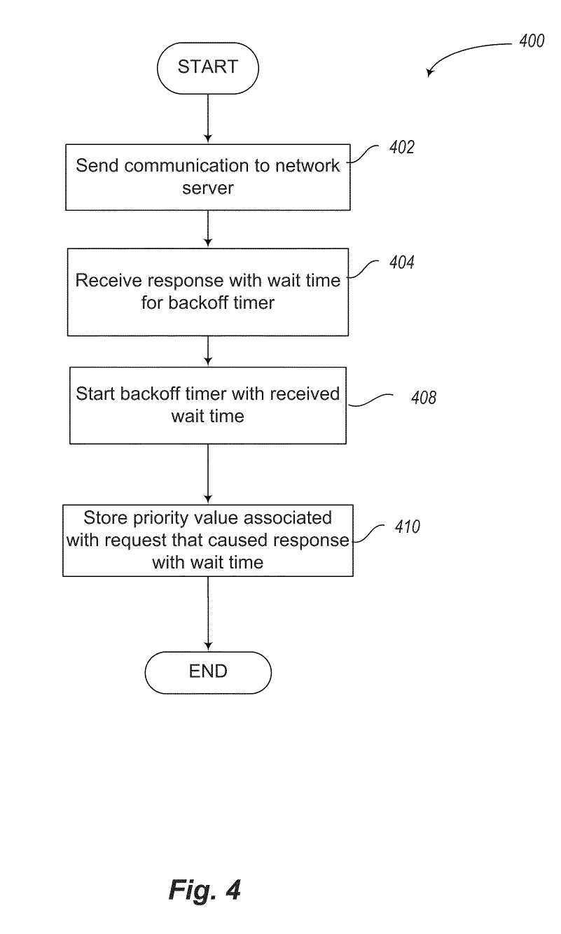

FIG. 4 is a process flow diagram illustrating communications between a network controller, e.g., network controller 206, and a UE, e.g., UE 15, in a wireless network environment in accordance with an embodiment. It is assumed that the UE is configured as a dual-priority device. For example, the UE may be configured to provide an ability to override, in some cases, low priority associated with the device or with one or more applications residing on the device. (It should be understood that “dual priority” in the context of this disclosure may mean two or more priorities. The example with two priorities is provided merely for illustrative purposes.)

The process 400 begins at block 402, where the UE may send a request (e.g., connection request) to the network controller. As discussed above, there may be different types of communications initiated by the mobile device, such as, for example, an RRC Connection Request. As described above in reference to FIG. 2, if the network is congested above a certain determined level that allows establishing a connection with the device the network controller may respond with a rejection message (e.g., the network controller may send the RRC Connection Reject message described above) along with a wait time value, as illustrated by block 404. At block 408, the received wait time may be used to start a backoff timer that determines the time period within which the device may refrain from sending another request to the network controller. At block 410, a priority value (e.g., default (low) priority or normal priority) associated with the device's request may be stored by the device for future use.

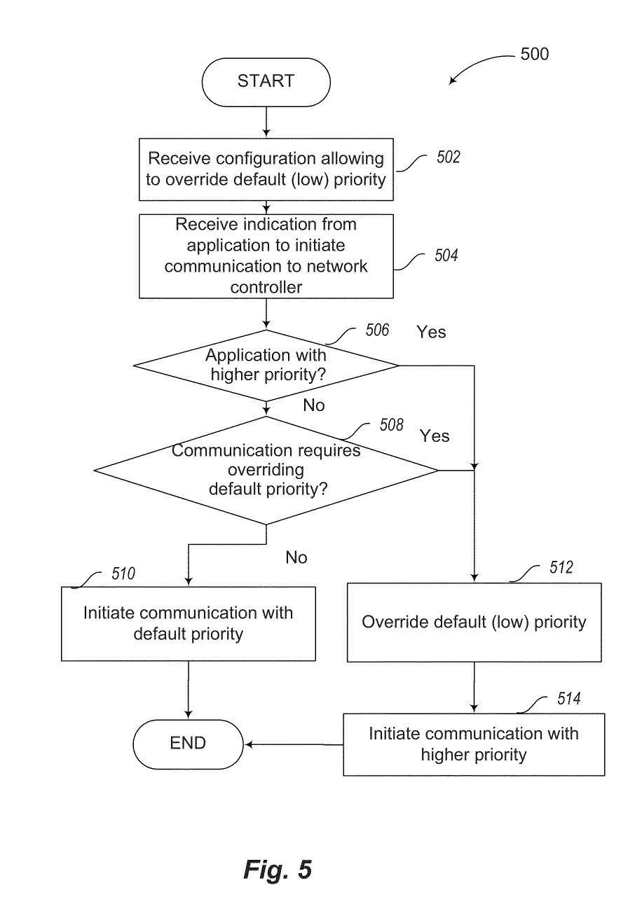

FIG. 5 is a process flow diagram for handling dual-priority communications by user equipment, e.g., UE 15, in a wireless network environment in accordance with some embodiments. The process 500 begins at block 502, where a UE may receive a configuration providing an ability to override a default (e.g., low) priority associated with the UE and/or applications residing on the UE. For example, a new configuration parameter may be added to the UE configuration that may override the default priority. More specifically, a new configuration parameter may be added to the non-access stratum (NAS) configuration of the UE that allows for overriding of the NAS low priority indicator setting. In another example, a new configuration parameter may be added to the non-access stratum configuration that allows for overriding an Extended Access Barring configuration, as discussed above. The configuration parameter may be provided by a provider of a wireless communication network in which the UE is operating. As described above, the wireless communication network may comprise UTRAN or E-UTRAN, for example.

At block 504, a communication, such as a request message to a network controller, e.g., network controller 206, may be initiated by the UE. For example, an application residing on the UE may indicate a need to send a request to the network controller. As discussed above, a request to the network controller may be any type of request, such as RRC Connection Request. In other examples, a UE may initiate a request to the network controller in connection with an attach procedure (e.g., request to “attach” the UE to the network), tracking area update procedure, location updating procedure, routing area update procedure, service request procedure, and the like. In yet another example, an application may initiate a request (e.g., request to send information to an end user via the network).

At decision block 506 it may be determined whether an application initiating a communication is associated with a priority level that is different than a default priority. For example, it may be determined whether an application is associated with a normal priority. If it is determined that the application initiating the communication is not associated with a priority other than a default priority, the process 500 moves to decision block 508. Otherwise, the process 500 moves to block 512.

At decision block 508 it may be determined whether a communication from the application requires overriding the default priority. As discussed above, some applications that typically are associated with, and send requests or other communications associated with, default (low) priority, occasionally may need to send communications associated with higher priority. For example, an electricity meter may want to send an alarm with “normal priority,” for example, if the meter is being tampered with or is being vandalized, as opposed to a daily report that is typically sent with a low priority.

If it is determined that the communication does not require overriding a default priority, at block 510 the communication is initiated (e.g., sent) to the controller with a default priority indication and is treated by the network controller according to an indicated priority.

If it is determined that the communication requires overriding a default (e.g., low) priority, the process 500 moves to block 512, where the low priority is overridden, for example, using the configuration setting as described in reference to block 502. At block 514, a communication is initiated (e.g., sent) to the controller with a different level of priority which is allowed by the dual priority character of the UE configuration (e.g., normal priority).

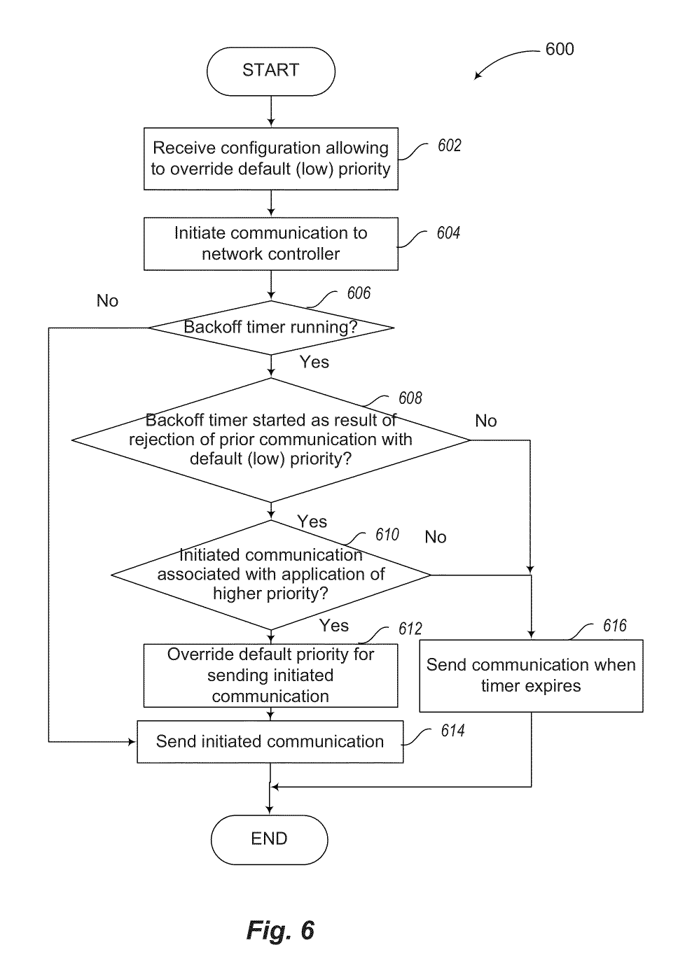

FIG. 6 is a process flow diagram for handling dual-priority communications by user equipment in a congested wireless network environment in accordance with some embodiments. As described above in reference to FIG. 4, in case of a congested network, the network controller may respond to a communication (e.g., request to connect) from UE with a rejection message that may include a wait time value directing the UE to refrain from sending communications to the network until the wait time expires. The UE may start a backoff timer with the received wait time value and store the priority value associated with the UE earlier communication that triggered the rejection from the network.

In some situations, the received wait time value may be ignored by the UE. However, for the purpose of an embodiment illustrated in FIG. 6 it is assumed that the UE may not ignore the received wait time value.

The process 600 begins at block 602, where the UE may be configured with a configuration providing an ability to override a default (e.g., low) priority associated with the UE and/or applications residing on the UE, similar to the example described above in reference to FIG. 5. At block 604, a communication to a network controller may be initiated by the UE. As described in reference to FIG. 5, a communication may relate to connection (e.g., a PDN connection) or other Mobility Management functions (e.g., attach procedure, tracking area update procedure, location updating procedure, routing area update procedure, service request procedure, and the like). At decision block 606 it may be determined whether a backoff timer associated with UE is running If it is determined that a backoff timer is not running, the process moves to block 614, where the initiated communication may be sent to the network controller.

If it is determined that the backoff timer is running, at decision block 608 it may be determined whether the backoff timer was started as a result of a prior communication (e.g., a response to a communication sent by the UE) that is associated with a default (e.g., low) priority. For example, the backoff timer may have been started due to prior Mobility Management functions, for example, NAS request messages such as attach request, tracking area update request, or extended service request. As described in reference to FIG. 4 (block 410), when the backoff timer starts, the priority value (low or normal) associated with the communication that triggers the backoff timer may be stored. Accordingly, a priority level of a communication that triggered the backoff timer may be determined at decision block 608. If it is determined that the backoff timer was started in connection with a communication having a priority level other than default (e.g., normal priority), the process 600 moves to block 616, where the initiated communication may be sent only upon an expiration of the backoff timer.

If it is determined that the backoff timer was started in connection with a prior communication having a low priority level (e.g., a prior NAS request message having a low priority level), at decision block 610 it may be determined whether the initiated communication is associated with a priority other than a default priority, e.g., normal priority. Some instances of requests that may be associated with a normal priority are described above in reference to FIG. 5 (block 508). If it is determined that the initiated communication is not associated with a priority other than a default (low) priority, the process 600 moves to block 616, where the initiated communication may be sent only upon an expiration of the backoff timer. If it is determined that the initiated communication is associated with a priority other than a default (low) priority, at block 612 the UE default (low) priority may be overridden. At block 614, the initiated communication may be sent with a priority other than default, e.g., normal priority, which is higher than the default low priority.

Various embodiments may include some of the following impacts to core technology specification to enable support for multiple priority applications/configurations. The impacts may effect, e.g., the UE configuration, attach request, handling of location area updates (LAUs)/routing area updates (RAUs)/tracking area updates (TAU), handling of congestion management, EPS session management (ESM) setting, and EAB setting.

With respect to UE configuration, the UE may continue to have NAS signaling low priority configuration as per the NAS_SignalingPriority leaf in a NAS configuration MO supporting low priority applications. However, the UE may need to be able to override this configuration for other non low-priority applications so that low priority is not included in NAS messages (other than those for emergency services and for access classes 11-15). An additional configuration option may be added to the NAS configuration MO to specify that the UE has the capability to override the low priority indicator as it may support other non-low priority applications as well.

With respect to the attach request, in current specifications if the attach request is rejected due to network congestion or overload conditions the UE may initiate a backoff timer and the UE shall not initiate another attach request while this backoff timer is running This behavior will change, in present embodiments, for non low-priority applications. The UE may be allowed to override the network congestion conditions and initiate an attach request for non low priority applications by, e.g., appropriately setting low-priority indicator in the device properties IE in NAS messages.

With respect to handling of LAU/RAU/TAU, in the current specifications if the network is congested and if the UE is running a backoff timer, then LAU/RAU/TAU procedures are not initiated until the backoff timer expires or is stopped. However if the UE is able to successfully complete the attach request for a non-low priority application and if this connection stays active, then the UE should be allowed to initiate LAU/RAU/TAU procedures as long as any EPS bearer contexts are active, even though the backoff timer for low priority application may be running.

With respect to handling congestion management, there should be no impact to congestion and overload management for low priority applications. However, it may be possible that in certain conditions NAS messages without low priority indicator may get rejected as well and the UE may be asked to initiate a backoff timer. It may be desirable for the UE to maintain a single set of backoff timers for different applications (low priority and other non-low priority applications) in such cases. Under such conditions the procedures and guidelines for low priority applications may apply to other non low priority applications as well.

With respect to ESM setting, ESM setting of device properties may be established by the UE based on priority of an application using a PDN connection, e.g., the UE may set device properties of the ESM messages based on the PDN connection priority. In some embodiments, the UE may manage a session management back-off timer on a per PDN connection basis, as opposed to the entire device/UE basis. For example, the UE may control a session management back-off timer for each of a plurality of PDN connections. In other embodiments, a single session management timer may be used to control multiple PDN connections. The process for setting the device properties to be based on the application that is running may need to be modified. Further, session management procedures may need to be modified to reflect this situation.

A UE configured for NAS signaling low priority may indicate this by including a device properties IE, in an appropriate NAS message, with its low priority indicator to “MS is configured for NAS signaling low priority,” except for certain situations in which the UE may set the low-priority indicator to “MS is not configured for NAS signaling low priority.” Various embodiments provide that these situations include, but are not limited to when the UE, which provides dual priority support and is configured to override the NAS signaling low priority indicator: is establishing a PDN connection with the low priority indicator set to “MS is not configured for NAS signalling low priority”; is performing EPS session management procedures related to the PDN connection established with low priority indicator set to “MS is not configured for NAS signalling low priority”; and/or has a PDN connection established by setting the low priority indicator to “MS is not configured for NAS signaling low priority” and is performing EPS mobility management procedures. It may be understood that ‘establishing a PDN connection with the low-priority indicator set to “MS is not configured for NAS signaling low priority”’ may be understood to mean that the one or more NAS messages used to establish the PDN connection have device element IE's with low-priority indicators set indicate “MS is not configured for NAS signalling low priority.” Similarly, the one or more NAS messages used to perform the EPS session management procedures, and/or perform the EPS mobility management procedures, may have the low priority indicators of their device element IEs similarly set.

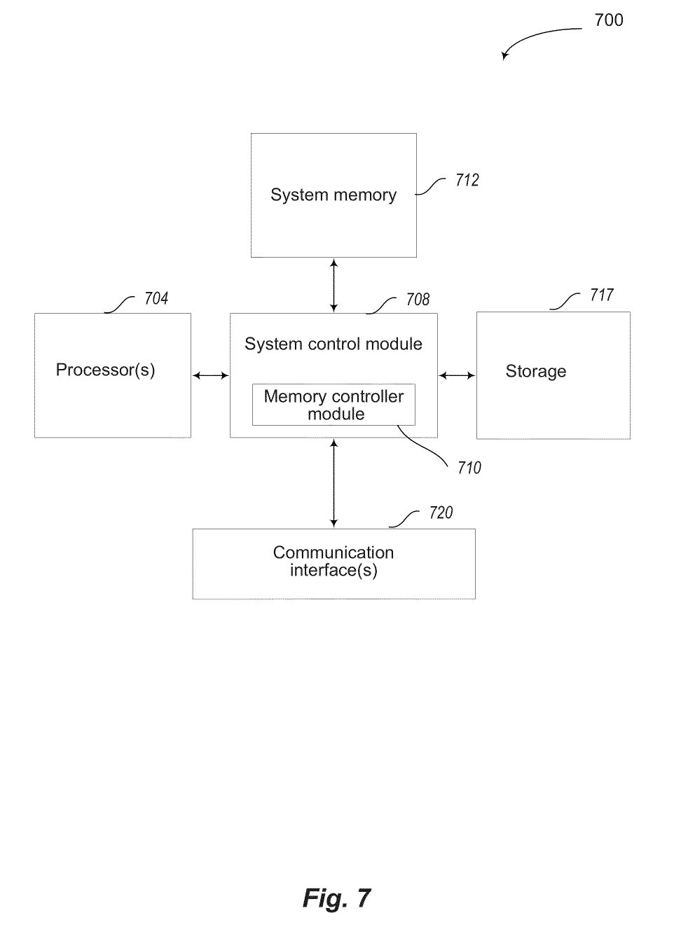

Embodiments of the present disclosure may be implemented into a system using any suitable hardware and/or software to configure as desired. FIG. 7 schematically illustrates an example system that may be used to practice various embodiments described herein. FIG. 7 illustrates, for one embodiment, an example system 700 having one or more processor(s) 704, system control module 708 coupled to at least one of the processor(s) 704, system memory 712 coupled to system control module 708, non-volatile memory (NVM)/storage 717 coupled to system control module 708, and one or more communications interface(s) 720 coupled to system control module 708.

In some embodiments, the system 700 may be capable of functioning as the UE 15 as described herein. In other embodiments, the system 700 may be capable of functioning as the one or more nodes 45 or one or more servers 50 of FIG. 1 or otherwise provide logic/module that performs functions as described for eNB 40, 42 and/or other modules described herein. In some embodiments, the system 700 may include one or more computer-readable media (e.g., system memory or NVM/storage 717) having instructions and one or more processors (e.g., processor(s) 704) coupled with the one or more computer-readable media and configured to execute the instructions to implement a module to perform actions described herein.

System control module 708 for one embodiment may include any suitable interface controllers to provide for any suitable interface to at least one of the processor(s) 704 and/or to any suitable device or component in communication with system control module 708.

System control module 708 may include memory controller module 710 to provide an interface to system memory 712. The memory controller module 710 may be a hardware module, a software module, and/or a firmware module.

System memory 712 may be used to load and store data and/or instructions, for example, for system 700. System memory 712 for one embodiment may include any suitable volatile memory, such as suitable DRAM, for example. In some embodiments, the system memory 712 may include double data rate type four synchronous dynamic random-access memory (DDR4 SDRAM).

System control module 708 for one embodiment may include one or more input/output (I/O) controller(s) to provide an interface to NVM/storage 717 and communications interface(s) 720.

The NVM/storage 717 may be used to store data and/or instructions, for example. NVM/storage 717 may include any suitable non-volatile memory, such as flash memory, for example, and/or may include any suitable non-volatile storage device(s), such as one or more hard disk drive(s) (HDD(s)), one or more compact disc (CD) drive(s), and/or one or more digital versatile disc (DVD) drive(s), for example.

The NVM/storage 717 may include a storage resource physically part of a device on which the system 700 is installed or it may be accessible by, but not necessarily a part of, the device. For example, the NVM/storage 717 may be accessed over a network via the communications interface(s) 720.

Communications interface(s) 720 may provide an interface for system 700 to communicate over one or more network(s) and/or with any other suitable device. The system 700 may wirelessly communicate with the one or more components of the wireless network in accordance with any of one or more wireless network standards and/or protocols.

For one embodiment, at least one of the processor(s) 704 may be packaged together with logic for one or more controller(s) of system control module 708, e.g., memory controller module 710. For one embodiment, at least one of the processor(s) 704 may be packaged together with logic for one or more controllers of system control module 708 to form a System in Package (SiP). For one embodiment, at least one of the processor(s) 704 may be integrated on the same die with logic for one or more controller(s) of system control module 708. For one embodiment, at least one of the processor(s) 704 may be integrated on the same die with logic for one or more controller(s) of system control module 708 to form a System on Chip (SoC).

In various embodiments, the system 700 may be, but is not limited to, a server, a workstation, a desktop computing device, or a mobile computing device (e.g., a laptop computing device, a handheld computing device, a tablet, a netbook, etc.). In various embodiments, the system 700 may have more or less components, and/or different architectures. For example, in some embodiments, the system 700 may include one or more of a camera, a keyboard, liquid crystal display (LCD) screen (including touch screen displays), non-volatile memory port, multiple antennas, graphics chip, application-specific integrated circuit (ASIC), and speakers.

According to various embodiments, the present disclosure describes a device, comprising one or more computer-readable media having instructions; and one or more processors coupled with the one or more computer-readable media and configured to execute the instructions to configure, as a default configuration, the device with a first priority level for machine-type communications; receive a notification from an application associated with the device, the notification indicating that the application generated a communication to a network controller, the communication being associated with a second priority level that is higher than the first priority level; and in response to the notification, configure, as an override configuration, the device with the second priority level for machine-type communications.

According to various embodiments, the present disclosure describes a system comprising a network controller having a controller processor and a controller memory having instructions stored thereon that, when executed on the controller processor, cause the controller processor to provide a wait time value in response to a first communication to the network controller. The system further includes a device configured with a first priority level for machine-type communications, the device having a device processor and a device memory having instructions stored thereon that, when executed on the device processor, cause the device processor to generate a second communication to the network controller; determine whether a backoff timer associated with the first communication is running; and based on the determination, determine whether to send the second communication to the network controller.

According to various embodiments, the present disclosure describes a computer-implemented method comprising enabling a dual priority configuration, the enabling including a default configuration with a first priority level and an ability to override the first priority level and assign a second priority level, the second priority level being higher than the first priority level; receiving an indication of a communication to be sent to a network controller, the communication being associated with the second priority level; and sending the communication with the second priority level to the network controller.

According to various embodiments, the present disclosure describes a computer-readable storage medium having instructions stored thereon that, when executed on a computing device, cause the computing device to configure a wireless device with a dual priority configuration, the configuring including assigning a default configuration associated with a first priority level and providing an ability to override the first priority level and assign a second priority level, the second priority level being higher than the first priority level; receive an indication of a communication to be sent to a network controller, the communication being associated with the second priority level; determine whether a backoff timer associated with an earlier communication is running; determine whether the earlier communication is associated with the first priority level; and send the communication when it is determined that the backoff timer is running and the earlier communication is associated with the first priority level.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

What is claimed is:

1. One or more computer-readable media having instructions that, when executed, cause a device to:
configure, as a default configuration, the device with a first priority level;
determine, based on a non-access stratum (NAS) configuration management object (MO) parameter of the device, that the device has an ability to override the default configuration;
receive, from an upper layer, a request to establish a packet data network (PDN) connection associated with a second priority level that is higher than the first priority level; and
configure, as an override configuration, the device with the second priority level, based on the determination that the device has the ability to override the default configuration and the receipt of the request.

2. The one or more computer-readable media of claim 1, wherein the default configuration is associated with a NAS low priority setting or an extended access barring (EAB) configuration.

3. The one or more computer-readable media of claim 1, wherein the PDN connection associated with the second priority level is to be established with a low priority indicator set to indicate that the device is not configured for NAS signaling low priority.

4. The one or more computer-readable media of claim 1, wherein the instructions, when executed, further cause the device to:
initiate an envolved packet system (EPS) session management communication related to the PDN connection with a network controller.

5. The one or more computer-readable storage media of claim 1, wherein the device is a machine-to-machine device.

6. A device, comprising:
a system control logic to:
determine that a backoff timer is running; and
determine that the device has established or is establishing a packet data network (PDN) connection associated with a first priority level, and that the backoff timer was started due to a first request message associated with a second priority level that is lower than the first priority level; and
a communication interface coupled with the system control logic, the communication interface to:
transmit a second request message to a network controller while the backoff timer is running.

7. The device of claim 6, wherein the system control logic is further to receive the second request message from an upper layer.

8. The device of claim 6, wherein the PDN connection associated with the first priority level was established or is being established without a non-access stratum (NAS) signaling low priority indication.

9. The device of claim 6 wherein the second request message is a tracking area update request message or a service request message.

10. The device of claim 6, wherein the first request message is an attach request, a tracking area update request, or an extended service request message.

11. The device of claim 6, wherein the device is a machine-to-machine device.

12. A device, comprising:
a system control logic to:
determine that a backoff timer is running; and
determine that a packet data network (PDN) connection associated with a first priority level is not established or that the backoff timer was not started due to a first request message associated with a second priority level that is lower than the first priority level; and
a communication interface coupled with the system control logic, the communication interface to:
transmit a second request message to a network controller when the backoff timer expires or is stopped.

13. The device of claim 12, wherein the system control logic is further to receive the second request message from an upper layer.

14. The device of claim 12 wherein the second request message is a tracking area update request message or a service request message.

15. The device of claim 12, wherein the first request message is an attach request, a tracking area update request, or an extended service request message.

16. The device of claim 12, wherein the device is a machine-to-machine device.

17. A method, comprising:
configuring a device with a dual-priority configuration by assigning a default configuration associated with a first priority level and providing an ability to override the default configuration, as an override configuration associated with a second priority level that is higher than the first priority level;
determining that a backoff timer is running;
determining that the device has established or is establishing a packet data network (PDN) connection associated with the second priority level, and that the backoff timer was started due to a first request message associated with the first priority level; and
transmitting a second request message to a network controller while the backoff timer is running.

18. The method of claim 17, further comprising: receiving the second request message from an upper layer;

19. The method of claim 17, further comprising:
setting a non-access stratum (NAS) configuration management object (MO) parameter of the device to indicate that the device has the ability to override the default configuration.

20. The method of claim 17, wherein the default configuration is associated with a non-access stratum (NAS) low priority setting or an extended access barring (EAB) configuration.

21. The method of claim 17, wherein the second request message is a tracking area update request message or a service request message

22. The method of claim 17, wherein the device is a machine-to-machine device.

23. A method, comprising:
configuring a device with a dual-priority configuration by assigning a default configuration associated with a first priority level and providing an ability to override the default configuration, as an override configuration associated with a second priority level that is higher than the first priority level;
determining that a backoff timer is running;
determining that a packet data network (PDN) connection associated with the second priority level is not established, or that the backoff timer was not started due to a first request message associated with the first priority level; and
transmitting a second request message to a network controller when the backoff timer expires or is stopped.

24. The method of claim 23, further comprising: receiving the second request message from an upper layer;

25. The method of claim 23, further comprising:
setting a non-access stratum (NAS) configuration management object (MO) parameter of the device to indicate that the device has the ability to override the default configuration.

26. The method of claim 23, wherein the default configuration is associated with a non-access stratum (NAS) low priority setting or an extended access barring (EAB) configuration.

27. The method of claim 23, wherein the second request message is a tracking area update request message or a service request message

28. The method of claim 23, wherein the device is a machine-to-machine device.
